(19) United States
(12) Patent Application Publication
(10) Pub. No.: US 2002/0054026 A1
(43) Pub. Date: May 9, 2002

(54) Synchronized transmission of recorded writing data with audio

(76) Inventors: Bradley Stevenson, Wilmington, MA (US); Dan Winkler, Methuen, MA (US); Ashley Woodsom, Allston, MA (US); Travell Perkins, Cambridge, MA (US)

Correspondence Address: WILSON SONSINI GOODRICH & ROSATI, 650 PAGE MILL ROAD, PALO ALTO, CA, 943041050

(21) Appl. No.: 09/836,877

(22) Filed: Apr. 17, 2001

Related U.S. Application Data
(60) Provisional application No. 60/198,085, filed on Apr. 17, 2000.

(51) Int. Cl. G09G 5/00

(52) U.S. Cl. 345/173; 345/179; 345/581

(57) ABSTRACT

A method is provided for recording writing and audio from a writing session in a manner such that a depiction of the writing can be replayed in a synchronized fashion with the audio, the method comprising: recording movement of a writing element relative to a writing surface during a writing session using a writing capture device which produces writing data corresponding to positions of the writing element relative to the writing surface at sampled points in time; recording audio present during the writing session using an audio capture device to form audio data; associating time stamps with the writing and audio data; forming stroke vector data from the writing data by grouping the writing data into groups of temporally proximate writing data points based on the time stamps associated with the writing data, each group of temporally proximate writing data points defining a stroke vector that reflects a direction and magnitude of movement of the writing element relative to the writing surface over a period of time spanned by the writing data points in the group; and storing the time stamped stroke vector data and time stamped audio data to memory.

### RELATIONSHIP TO COPENDING APPLICATIONS

This application is a continuation-in-part of U.S. Provisional Application Serial No. 60/198,085, filed Apr. 17, 2000, which is incorporated herein by reference in its entirety.

### BACKGROUND OF THE INVENTION

1. Field of the Invention

The present invention relates to the transmission of data corresponding to writing that has been electronically recorded in combination with audio.

2. Description of Related Art

Various technologies have been developed for capturing and storing writting as the writing is performed. For example, digitized writing surfaces such as electronic whiteboards or SMARTBOARDS have been developed. These electronic whiteboards serve as the actual input device (e.g. an electronic template) for capturing the handwritten data. The whiteboards may be active or passive electronic devices where the user writes on the surface with a special stylus. The active devices may be touch sensitive, or responsive to a light or laser pen wherein the whiteboard is the detector that detects the active signal. The passive electronic boards tend to use large, expensive, board-sized photocopying mechanisms.

More recently, ultrasound systems such as MIMIO™, described in U.S. Pat. Nos. 6,211,863, 6,191,778, 6,177,927, 6,147,681, 6,124,847, 6,111,565, 6,104,387, and 6,100,877 and EBEAM™ have been developed for capturing and storing writting.

The present invention relates to software tools adapted to better utilize the data produced by these systems.

### SUMMARY OF THE INVENTION

A method is provided for recording writing and audio from a writing session in a manner such that a depiction of the writing can be replayed in a synchronized fashion with the audio, the method comprising: recording movement of a writing element relative to a writing surface during a writing session using a writing capture device which produces writing data corresponding to positions of the writing element relative to the writing surface at sampled points in time; recording audio present during the writing session using an audio capture device to form audio data; associating time stamps with the writing and audio data; forming stroke vector data from the writing data by grouping the writing data into groups of temporally proximate writing data points based on the time stamps associated with the writing data, each group of temporally proximate writing data points defining a stroke vector that reflects a direction and magnitude of movement of the writing element relative to the writing surface over a period of time spanned by the writing data points in the group; and storing the time stamped stroke vector data and time stamped audio data to memory.

According to this method, the stroke vector data may optionally be stored in a compressed format, preferably a compressed loss less format.

According to this method, each stroke vector preferably comprises temporally proximate writing data points spanning a time period of less than 5000 ms, preferably less than 2500 ms, more preferably less than 1000 ms and most preferably less than 500 ms.

Optionally, information regarding the writing session such as writing attributes, writing speed, writing surface size, and pen pressure may also be stored.

According to this method, a same time source is preferably used to time stamp the writing and audio data.

Also according to this method, the writing data is preferably sampled at a rate of at least 40 points per/second, more preferably at least 60 points per/second, and most preferably at least 80 points per/second.

Also according to this method, video of the writing session may also be stored with the writing and audio data.

A method is also provided for recording writing and audio from a writing session in a manner such that a depiction of the writing can be replayed in a synchronized fashion with the audio, the method comprising: recording movement of a writing element relative to a writing surface during a writing session using a writing capture device which produces writing data corresponding to positions of the writing element relative to the writing surface at sampled points in time; recording audio present during the writing session using an audio capture device to form audio data; associating time stamps with the writing and audio data; forming stroke vector data from the writing data by grouping the writing data into groups of temporally proximate writing data points based on the time stamps associated with the writing data, each group of temporally proximate writing data points defining a stroke vector that reflects a direction and magnitude of movement of the writing element relative to the writing surface over a period of time spanned by the writing data points in the group; and displaying a depiction of writing on the writing surface over time based on the stroke data in combination with producing audio from the audio data where the time stamps associated with the writing and audio data are used to synchronize the displayed depiction of writing on the writing surface with the produced audio.

According to this method, each stroke vector preferably comprises temporally proximate writing data points spanning a time period of less than 5000 ms, preferably less than 2500 ms, more preferably less than 1000 ms and most preferably less than 500 ms.

Optionally, information regarding the writing session such as writing attributes, writing speed, writing surface size, and pen pressure may also be stored.

According to this method, a same time source is preferably used to time stamp the writing and audio data.

Also according to this method, the writing data is preferably sampled at a rate of at least 40 points per/second, more preferably at least 60 points per/second, and most preferably at least 80 points per/second.

Also according to this method, video of the writing session may also be displayed with the writing and audio data.

A method is also provided for recording writing and audio from a writing session in a manner such that a depiction of the writing can be replayed in a synchronized fashion with the audio, the method comprising: recording movement of a writing element relative to a writing surface during a writing session using a writing capture device which produces writing data corresponding to positions of the writing element relative to the writing surface at sampled points in time; recording audio present during the writing session using an audio capture device to form audio data; associating time stamps with the writing and audio data; forming stroke vector data from the writing data by grouping the writing data into groups of temporally proximate writing data points based on the time stamps associated with the writing data, each group of temporally proximate writing data points defining a stroke vector that reflects a direction and magnitude of movement of the writing element relative to the writing surface over a period of time spanned by the writing data points in the group; transmitting the stroke vector data and the audio data to a location remote relative to the writing session; and displaying at the remote location a depiction of writing on the writing surface over time based on the stroke data in combination with producing audio from the audio data where the time stamps associated with the writing and audio data are used to synchronize the displayed depiction of writing on the writing surface with the produced audio.

According to this method, the stroke vector data may optionally be transmitted in a compressed format, preferably a compressed loss less format.

According to this method, the depiction of writing may be displayed at the remote location in combination with the audio in real time relative to the writing.

Also according to this method, the stroke data and audio data may be transmitted as two separate data streams or as a single data stream.

Also according to this method, the stroke data and audio data may be transmitted by any mechanism including over a network.

According to this method, each stroke vector preferably comprises temporally proximate writing data points spanning a time period of less than 5000 ms, preferably less than 2500 ms, more preferably less than 1000 ms and most preferably less than 500 ms.

Optionally, information regarding the writing session such as writing attributes, writing speed, writing surface size, and pen pressure may also be stored.

According to this method, a same time source is preferably used to time stamp the writing and audio data.

Also according to this method, the writing data is preferably sampled at a rate of at least 40 points per/second, more preferably at least 60 points per/second, and most preferably at least 80 points per/second.

Also according to this method, video of the writing session may also be stored with the writing and audio data.

In regard to each of the above methods, it is noted that computer readable medium is also provided that is useful in association with a computer which includes a processor and a memory, the computer readable medium encoding logic for performing any of the methods described herein. Computer systems for performing any of the methods are also provided, such systems including a processor, memory, and computer executable logic which is capable of performing one or more of the methods described herein. Networked computer systems for performing any of the methods are also provided, such networked systems including processors, memory, and computer executable logic which is capable of performing one or more of the methods described herein.

### BRIEF DESCRIPTION OF THE FIGURES

FIG. 1 illustrates someone writing information on a whiteboard while giving an oral lecture. Meanwhile, the writing and audio is electronically recorded, synchronized, and streamed over a network and/or saved to file.

FIG. 2 illustrates the network flow to view a writing and audio session live or archived.

FIG. 3 illustrates a simple distribution scenario, the writing data and audio data is captured, synchronized and stored. All the data is then emailed to someone who can open the email attachment, and see the presentation that was given on the whiteboard while listening to the audio that went along with the presentation.

FIG. 4 illustrates logic flow for software for synchronizing writing data with audio.

FIG. 5 illustrates logic flow for software for synchronizing writing data with audio.

FIG. 6 illustrates logic flow for software that can draw the writing data to the screen, as it plays the synchronized audio that went along with it.

### DETAILED DESCRIPTION

The present invention relates to software employed to synchronize audio recorded during a writing session with electronic writing data recorded during that same writing session. Once synchronized, the audio and electronic writing data can be stored to memory, played back at a later time, transmitted at a later time, or transmitted and played back in real time. Transmission may be over diverse computer networks which include local area networks and/or wide area networks such as the internet. In order to facilitate transmission of data, the electronic writing data can be a compressed loss less representation of the writing it corresponds to.

“Electronic writing data” as the term is used herein refers to data recorded by a device capable of recording writing made on a writing surface. Several examples of such devices have recently been developed that are capable of recording such writing. MIMIO™ manufactured by Virtual Ink and EBEAM™ manufactured by Electronics For Imaging are examples of devices adapted to use ultrasound to track dry eraser pen strokes on white boards, flip charts and other writing surfaces. Other examples of devices that have recently been developed to record writing data include, but are not limited to WACOM™ tablets, CROSS™ tablets, and other simular electronic writing devices. It is noted that the present invention is independent of the source of the electronic writing data and thus may be used in conjunction with any device which produces said electronic writing data.

Electronic writing data refers to the data encoding the actual writing movements made by the person writing on the device, i.e. whiteboard, paper, flip chart, writing tablet, or PC-Tablet. Unlike video, which is a compressed approximation of an image, electronic writing data is a precise representation of the actual writing movements of a writing element relative to a writing surface as they are made and simultaneously recorded by the electronic transcription device. Electronic writing data thus does not encode an image. Rather, it encodes the sequential formation of a plurality of image fragments (vectors or strokes) created by the action of the writing element moving relative to the writing surface. Because electronic writing data corresponds to a high resolution vector based format, it can be scaled, unlike video, with no visible degradation.

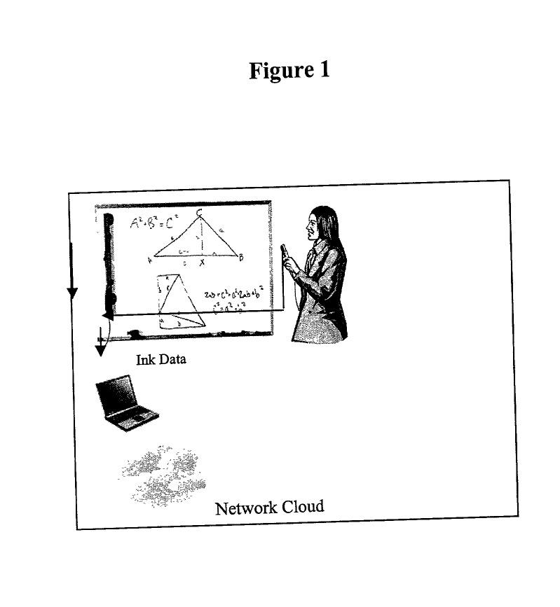

FIG. 1 illustrates a flow diagram for synchronizing electronic writing data with audio. As illustrated, data is first captured using an electronic capture device. The electronic writing data is then streamed into a computer. Various forms of information may be associated with the electronic writing data, such as writing attributes (color, pen width), writing speed, board size, pen pressure, etc.

Audio is also recorded using an audio capturing device during the writing recording. The recorded audio is also fed into a computer and time stamped.

Electronic writing data and audio data should both flow into the computer at a consistent sample rate. The preferred sample rate of electronic writing data is preferably at least 40 points per/second, more preferably at least 60 points per/second and more preferably at least 80 points per/second. Even higher sample rates will yield better results.

A time stamping method is used in order to synchronize the electronic writing data and audio data prior to the combined data being streamed and displayed. A common time source is used as a reference to time stamp the writing and audio data as the computer receives it. As soon as the electronic writing data or audio data arrives from the recording device, it is time stamped using the audio sample rate time calculation (See Equation 1) as its synchronization time source. If video is present, it may also use the audio time source for synchronization.

Equation 1

$${t}_{C} = {t}_{Ct} + \frac{( \frac{{n}_{Samples}}{{n}_{Bytes}} )}{r} + Δ t$$

where

t_{c}=Current Time

nₛₐₘₚₗₑₛ=Audio Samples from audio device

n_{Bytes}=Number of bytes per audio sample

r=Audio samples per/second

t=Amount of time since last audio sample was received

Writing data consists of all the data points recorded from the time the recording device begins recording writing until it stops recording writing. To stream and render the writing data in a form that looks pleasing to a person viewing the presentation, the writing data is broken down into a series of strokes, these strokes being smaller than a complete movement of a writing element. The resulting stroke data can then be compressed using a loss-less compression technique. Audio meanwhile is time stamped and compressed using standard audio compression techniques.

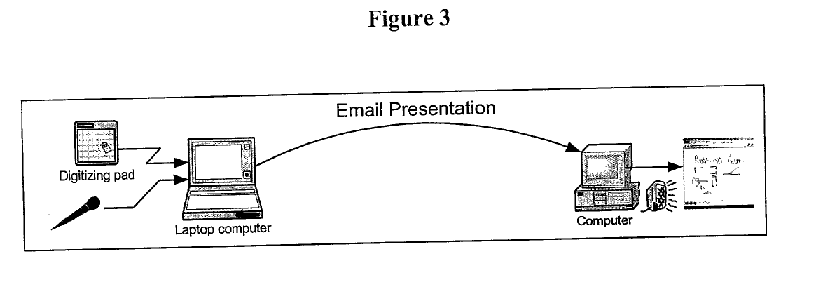

FIG. 3 illustrates a simple distribution scenario, the writing data and audio data is captured, synchronized and stored. All the data is then emailed to someone who can open the email attachment, and see the presentation that was given on the whiteboard while listening to the audio that went along with the presentation.

When the information is re-assembled by the viewing software, it is important to end up with the exact stroke objects that were assembled by the recording device. This is very different from the way standard video compression works, where once compressed the integrity of the ink data would be lost. Reassembly of information is done by dividing the writing data into stroke data comprising data-points covering a short duration, preferably less than 5,000 ms, preferably less than 2,500 ms, more preferably less than 1,000 ms, and most preferably less than 500 ms. At a sample rate of 1 data point per 10 ms, 1000 ms corresponds to 100 data points. As groups of data are combined and defined as stroke data, the resulting stroke data is time stamped, associated with a particular identification number, and sub identification number, converted into a binary format appropriate for streaming, and transmitted to a streaming server, file archive, or both.

The writing can be readily reassembled from the stroke data by the viewer software. The viewing software must first have any information to be associated with the electronic writing data, such as writing attributes (color, pen width), data sample rate, board size, etc. This information should be received by the viewer software before any rendering of writing data occurs. Assuming all the configuration data is present the viewer software buffers a certain amount of electronic writing and audio data, usually a duration of data not less than five seconds long. As the viewer software receives the small data strokes it rebuilds them into the larger strokes the creator had originally recorded on their writing surface using a writing element. A synchronization time-line is maintained by the viewer software to achieve synchronous rendering. This is the time line that determines when data should be displayed or played, and when information should be buffered. Data arriving prior to this timeline is placed in a data buffer until the synchronization time line exceeds the timestamp of the data. A viewer who joins a live session late will miss the original setup information. When the viewer software receives the stroke data before they receive the configuration data they simply buffer the stroke information, even if the data timestamp precedes the synchronization timeline. Audio and video information in this scenario are discarded, because once audio or video are considered occurring in the past from the current timeline there is no use doing anything with it. It is lost information that cannot be conveyed to the user. When the setup information arrives, the viewer software sets up the rendering surface to the correct size and configuration and starts rendering all the buffered strokes. When all stokes that should have been rendered according to the synchronization time line are rendered, the audio stream will start playing in sync with the stroke data.

With the setup information decoded from the data stream the viewer software knows things such as what size writing surface was used, what color it was, what the stroke sample rate was, pen color, pen width and pen pressure. With this information the viewer software can now display a changing image of the writing synchronized with audio that reflect what it looked like and sounded like when the originator created the writing. The speed of the writing strokes drawn by the content originator is directly proportional to the speed the viewer software draws them at. The writing speed information can be derived by dividing the number of data points contained in a stroke by the sample rate of the device that captured the writing data. The writing speed is important because it reflects an exact correlation between the spoken word, and the corresponding written action.

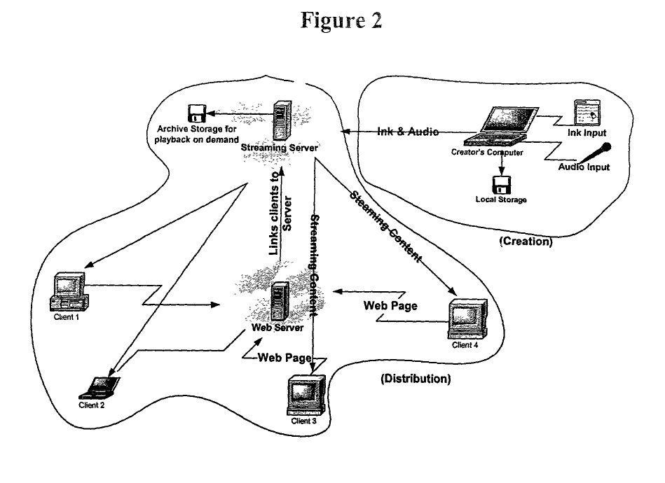

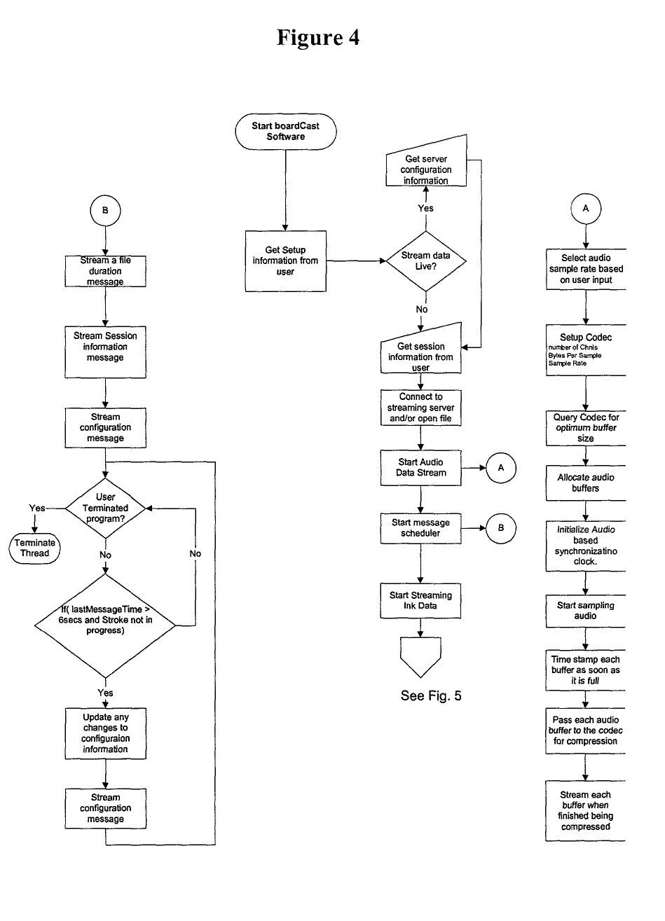

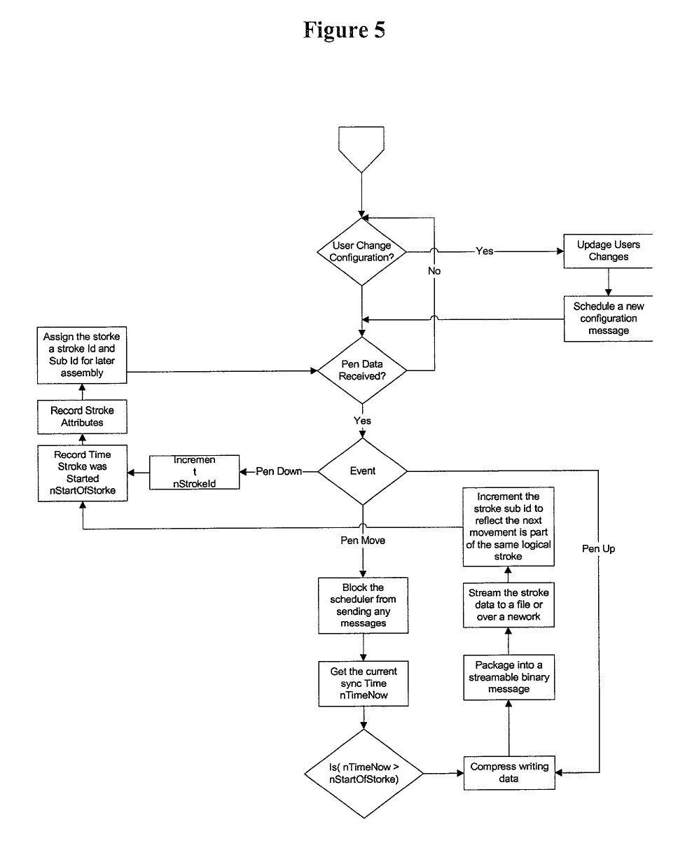

FIG. 2 illustrates electronic writing data and audio being synchronized and then stored locally as well as being streamed to a streaming server. FIGS. 4 and 5 illustrate logic flow for software for synchronizing writing data with audio. Once synchronized, the streaming server can then stream the broadcast live and/or archive it for later viewing.

Data streams corresponding to stroke data and audio data are each separately streamed out over a network, and/or streamed to a local file. After optionally being compressed and packetized, the data streams can be streamed to a server for live broadcast or later broadcast on demand. The data streams can also be streamed directly to a file for later playback.

During a live broadcast some packets may be lost by the network. The system is designed to rebroadcast data during breaks in the stroke data stream. This ensures that any stroke data lost in transport will eventually arrive. During playback on demand sessions packet delivery is guaranteed and this is not a problem.

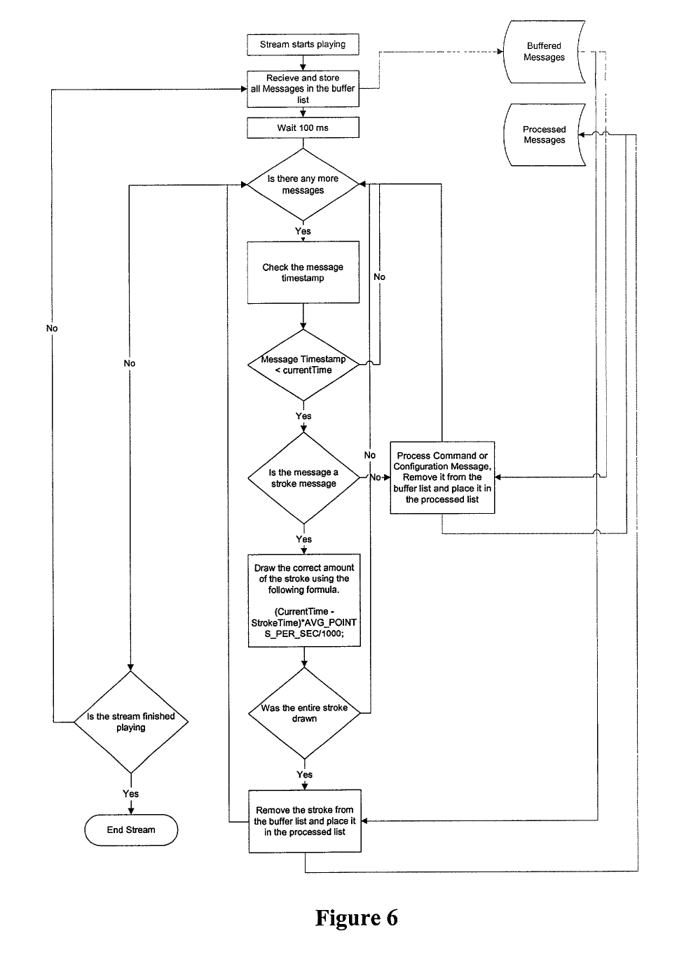

When a viewer wants to see a recorded writing session in combination with audio, the session can be viewed live as it is happening, played back from a server, or played back from a local file system. When the session is played back, the writing and audio data are synchronized. The two streams of data may be stored and streamed as two separate streams, and then played synchronized, or they could be woven into one single data stream. FIG. 6 illustrates logic flow for software that can be used to draw the writing data to the screen, as synchronized audio is played that went along with the writing.

FIG. 2 illustrates how an end user retrieves a synchronized writing data and audio presentation from a streaming server. The client clicks a link on a web page to the streaming content. The web server executes the script that starts a stream from the specified streaming server to the client requesting it. The script contains a command that instructs the viewers media player to play the two streams in parallel.

It is noted that a video stream may optionally be recorded, streamed, and viewed in combination with the writing data. This allows a person viewing the writing to also see the gestures of the person recording the data, i.e. a teacher at their whiteboard pointing to a concept already on the white board. The viewer's connection can be uni-directional so all page setup and configuration data must be transmitted often enough to provide a viewer joining in the middle of a session all the setup data they need to start playing the presentation to the client.

While the present invention is disclosed by reference to the preferred embodiments and examples detailed above, it is to be understood that these examples are intended in an illustrative rather than limiting sense, as it is contemplated that modifications and combinations will readily occur to those skilled in the art, which modifications and combinations will be within the spirit of the invention and the scope of the appended claims.

What is claimed is:

1. A method for recording writing and audio from a writing session in a manner such that a depiction of the writing can be replayed in a synchronized fashion with the audio, the method comprising:
recording movement of a writing element relative to a writing surface during a writing session using a writing capture device which produces writing data corresponding to positions of the writing element relative to the writing surface at sampled points in time;
recording audio present during the writing session using an audio capture device to form audio data;
associating time stamps with the writing and audio data;
forming stroke vector data from the writing data by grouping the writing data into groups of temporally proximate writing data points based on the time stamps associated with the writing data, each group of temporally proximate writing data points defining a stroke vector that reflects a direction and magnitude of movement of the writing element relative to the writing surface over a period of time spanned by the writing data points in the group; and
storing the time stamped stroke vector data and time stamped audio data to memory.

2. A method according to claim 1 wherein the stroke vector data is stored in a compressed format.

3. A method according to claim 1 wherein the stroke vector data is stored in a compressed loss less format.

4. A method according to claim 1 wherein each stroke vector comprises temporally proximate writing data points spanning a time period of less than 5000 ms.

5. A method according to claim 1 wherein each stroke vector comprises temporally proximate writing data points spanning a time period of less than 2500 ms.

6. A method according to claim 1 wherein each stroke vector comprises temporally proximate writing data points spanning a time period of less than 1000 ms.

7. A method according to claim 1 wherein each stroke vector comprises temporally proximate writing data points spanning a time period of less than 500 ms.

8. A method according to claim 1 further comprising storing information regarding the writing session selected from the group consisting of writing attributes, writing speed, writing surface size, and pen pressure.

9. A method according to claim 1 wherein a same time source is used to time stamp the writing and audio data.

10. A method according to claim 1 wherein the writing data is sampled at a rate of at least 40 points per/second.

11. A method according to claim 1 wherein the writing data is sampled at a rate of at least 60 points per/second.

12. A method according to claim 1 wherein the writing data is sampled at a rate of at least 80 points per/second.

13. A method for recording writing and audio from a writing session in a manner such that a depiction of the writing can be replayed in a synchronized fashion with the audio, the method comprising:
recording movement of a writing element relative to a writing surface during a writing session using a writing capture device which produces writing data corresponding to positions of the writing element relative to the writing surface at sampled points in time;
recording audio present during the writing session using an audio capture device to form audio data;
associating time stamps with the writing and audio data;
forming stroke vector data from the writing data by grouping the writing data into groups of temporally proximate writing data points based on the time stamps associated with the writing data, each group of temporally proximate writing data points defining a stroke vector that reflects a direction and magnitude of movement of the writing element relative to the writing surface over a period of time spanned by the writing data points in the group; and
displaying a depiction of writing on the writing surface over time based on the stroke data in combination with producing audio from the audio data where the time stamps associated with the writing and audio data are used to synchronize the displayed depiction of writing on the writing surface with the produced audio.

14. A method according to claim 13 wherein each stroke vector comprises temporally proximate writing data points spanning a time period of less than 5000 ms.

15. A method according to claim 1 wherein each stroke vector comprises temporally proximate writing data points spanning a time period of less than 2500 ms.

16. A method according to claim 13 wherein each stroke vector comprises temporally proximate writing data points spanning a time period of less than 1000 ms.

17. A method according to claim 13 wherein each stroke vector comprises temporally proximate writing data points spanning a time period of less than 500 ms.

18. A method according to claim 13 further comprising displaying the depiction of writing on the writing surface based on information regarding the writing session selected from the group consisting of writing attributes, writing speed, writing surface size, and pen pressure.

19. A method according to claim 13 wherein a same time source is used to time stamp the writing and audio data.

20. A method according to claim 13 wherein the writing data is sampled at a rate of at least 40 points per/second.

21. A method according to claim 13 wherein the writing data is sampled at a rate of at least 60 points per/second.

22. A method according to claim 13 wherein the writing data is sampled at a rate of at least 80 points per/second.

23. A method for recording writing and audio from a writing session in a manner such that a depiction of the writing can be replayed in a synchronized fashion with the audio, the method comprising:
recording movement of a writing element relative to a writing surface during a writing session using a writing capture device which produces writing data corresponding to positions of the writing element relative to the writing surface at sampled points in time;
recording audio present during the writing session using an audio capture device to form audio data;
associating time stamps with the writing and audio data;
forming stroke vector data from the writing data by grouping the writing data into groups of temporally proximate writing data points based on the time stamps associated with the writing data, each group of temporally proximate writing data points defining a stroke vector that reflects a direction and magnitude of movement of the writing element relative to the writing surface over a period of time spanned by the writing data points in the group;
transmitting the stroke vector data and the audio data to a location remote relative to the writing session; and
displaying at the remote location a depiction of writing on the writing surface over time based on the stroke data in combination with producing audio from the audio data where the time stamps associated with the writing and audio data are used to synchronize the displayed depiction of writing on the writing surface with the produced audio.

24. A method according to claim 23 wherein the stroke vector data is transmitted in a compressed format.

25. A method according to claim 23 wherein the stroke vector data is transmitted in a compressed loss less format.

26. A method according to claim 23 wherein each stroke vector comprises temporally proximate writing data points spanning a time period of less than 5000 ms.

27. A method according to claim 23 wherein each stroke vector comprises temporally proximate writing data points spanning a time period of less than 2500 ms.

28. A method according to claim 23 wherein each stroke vector comprises temporally proximate writing data points spanning a time period of less than 1000 ms.

29. A method according to claim 23 wherein each stroke vector comprises temporally proximate writing data points spanning a time period of less than 500 ms.

30. A method according to claim 23 further comprising displaying the depiction of writing on the writing surface based on information regarding the writing session selected from the group consisting of writing attributes, writing speed, writing surface size, and pen pressure.

31. A method according to claim 23 wherein a same time source is used to time stamp the writing and audio data.

32. A method according to claim 23 wherein the writing data is sampled at a rate of at least 40 points per/second.

33. A method according to claim 23 wherein the writing data is sampled at a rate of at least 60 points per/second.

34. A method according to claim 23 wherein the writing data is sampled at a rate of at least 80 points per/second.

35. A method according to claim 23 wherein the depiction of writing is displayed at the remote location in combination with the audio in real time relative to the writing.

36. A method according to claim 23 wherein a same time source is used to time stamp the writing and audio data.

37. A method according to claim 23 wherein the stroke data and audio data are transmitted as two separate data streams.

38. A method according to claim 23 wherein the stroke data and audio data are transmitted as a single data stream.

39. A method according to claim 23 wherein the stroke data and audio data are transmitted over a network.
